(19) United States
(12) Patent Application Publication
(10) Pub. No.: US 2005/0044264 A1
(43) Pub. Date: Feb. 24, 2005

(54) Device and method for transmitting a plurality of signals by means of multi-stage protocol processing

(75) Inventors: Jochen Grimminger, Munchen (DE); Andreas Kirstadter, Ebersberg (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/491,081

(22) PCT Filed: Sep. 24, 2002
(86) PCT No.: PCT/DE02/03593

(30) Foreign Application Priority Data
Sep. 27, 2001 (DE) 101 47 750.3

(51) Int. Cl. G06F 15/173

(52) U.S. Cl. 709/238

(57) ABSTRACT

The invention relates to a device and a method for transmitting a plurality of packet-oriented signals within networks (18, 19), especially for switching and routing in networks (18, 19). Said device comprises a plurality of port units (14) comprising at least one port (15), said ports being able to be connected to the networks; a transmission unit (16) which preferably has the function of a crossbar switch; and at least one first protocol unit (12) which analyses at least part of the signals and determines their destination. The inventive device comprises a plurality of other protocol units (17) which are directly associated with the port units (14) and which classify the signals according to their transmission protocol, in order to independently take on the protocol processing for part of the packets, and to transfer the protocol processing for the other part to the first protocol unit.

### CLAIM FOR PRIORITY

This application claims priority to International Application No. PCT/DE02/03593, which was published in the German language on Apr. 10, 2003, which claims the benefit of priority to German Application No. 10147750.3, which was filed in the German language on Sep. 27, 2001, the contents of which are hereby incorporated by reference.

### TECHNICAL FIELD OF THE INVENTION

The invention relates to a method and a device for transmitting a plurality of packet-oriented signals.

### BACKGROUND OF THE INVENTION

In conventional data networks, it is necessary to route the data in the form of data packets from a source to a destination. To this end, an appropriate transmission system is required. The transmission capacity, or data transfer rate, has risen dramatically in networks in recent years, with the result that the demands made on these transmission systems also rose steadily. This resulted in the need to develop transmission facilities, switches and routers in particular, exhibiting a data throughput performance in the multi-gigabit or even terabit range. With regard to such high transmission speeds, it is only possible to implement the required network protocols in a hardware form in order to be able to achieve the requisite response times.

Transmission facilities for these high transmission speeds are implemented according to one possibility through the use of an active backplane. In this situation, principally crossbar architectures which operate entirely in parallel are employed, with the result that the throughput achieved by facilities of this type is limited by the speed of the switching operations of the crossbar, by the number of individual ports and by the communications protocol used internally.

Crossbar architectures normally interoperate with a plurality of port chips which are connected by way of interfaces to a central crossbar chip. Known crossbar chips normally incorporate buffer memories offering intermediate storage for packets or cells in the event of collisions occurring.

Further components of the transmission facilities are contention resolution units (cell conflict resolution units) which control the traffic between the individual ports if one port is intended to receive data from a plurality of other ports. Patent Specifications 19935127.9 and 19935126.0 along with their referenced publications describe possible ways in which such cell conflicts can be resolved.

Buffer memories are a further component of transmission systems. These are required in order to be able to maintain control over peaks in the transfer rate in the case of systems having a variable data transfer rate—for example systems in which different services can be transmitted over the same lines. Furthermore, protocol processing units or corresponding chips on this buffer memory ascertain the next port to which the information packet or the cell is to be conveyed. The protocol processing units use the header and corresponding tables to determine to whom the packet or the cell needs to be forwarded. Thus, a plurality of tables may exist for a multi-protocol environment which need to be applied, for example, when processing ATM, MPLS and IP protocols.

A disadvantage of these known systems is the relatively high level of resources required for implementation since practically all the protocol mechanisms need to be implemented in a hardware form on account of the high transmission speed. In particular, the provision of buffer memories and associated high-speed transmission paths for the internal data transfer to and from the buffer memories results in a considerable portion of the overall resource requirement involved in the implementation of such types of transmission facilities.

The majority of transmission systems for packet-switched networks and their elements available on the market are based on hop-by-hop forwarding of the packets by the transmission systems. In this situation, the higher the protocol layer and its complexity on which the decision is based, the greater is the processing effort that is induced. As a rule, a decision is made on Layer 1 or Layer 2 of the communication layers. These layers are, however, as a rule dependent on the specific network topology which interconnects the transmission units. They do not as a rule include overlapping topologies.

In the past, therefore, simplified packet forwarding methods have been developed such as MPLS, ATM (see corresponding RFCs) etc. which can in part also be employed in overlapping topology mode.

As a result of the limited memory bandwidths, the larger transmission units comprise a plurality of protocol processing units which are interconnected by way of coupling units (for example the aforementioned active crossbar backplanes) (cf. for example DE 19935126.0). As a result of their simple structure and the low memory size requirements (made possible through coordination of the packet streams passing by way of the coupling units), the coupling units for this purpose have an extremely high performance which extends right into the terabit range. A corresponding structure for a switching center which also has an extremely high performance can be found in the publication J Chao: “Saturn: A Terabit Packet Switch Using Dual Round Robin” in IEEE Communications Magazine, December 2000, pp. 78-84. This publication describes a round robin method, according to which corresponding outputs ports are assigned to the input ports.

An important reason for developing simplified protocols such as ATM and MPLS was in order to simplify and abbreviate the path decision in the protocol processing units. On the basis of the prior art, however, the packets have always previously passed through the same processing units with the same number of protocol processing units. In the protocol processing units, different packet types undergo different forms of processing. As a rule, a distinction is made according to the type of the protocols.

The limited bandwidth of the packet buffer memories in the protocol processing units does, however, in addition limit the overall packet throughput per protocol processing unit. The corresponding interconnection (mentioned in 1.) of the protocol processing unit must be coordinated in the area of memory management by means of a corresponding additional protocol between the modules (in other words, essentially a large, distributed, virtual overall packet buffer is thus formed, cf. DE 19935127.9). However, this results on the one hand in a large bandwidth requirement for this additional protocol overhead and on the other hand in the need to integrate additional communication units for the corresponding distributed memory coordination protocols into the protocol processing unit.

On the other side, the coupling units have continued to become increasingly more powerful but only internal interfaces exist to the respective protocol processing units in which each packet is subjected to full and expensive processing.

### SUMMARY OF THE INVENTION

The invention provides a fast and more cost-effective transmission unit.

The invention lies in the execution of a protocol processing procedure involving at least two stages. Each port of a coupling unit thus has at least one protocol unit which is capable of carrying out a simple classification of the incoming packets and quickly processing simple protocols. In addition, connections from the coupling units are provided which are connected by way of a network inside or outside the transmission unit to a further protocol unit which is able to carry out the more complex analyses for protocols having a greater complexity level. Packets which correspond to simplified protocol concepts such as ATM and MPLS are thus processed directly in the coupling unit and immediately forwarded. Those packets or information relating to the packets are now routed to the more complex protocol processing units by way of the network which need to be processed there on the higher protocol layers. The corresponding packet forwarding is then effected by means of the coupling units. The coupling units also handle the forwarding of the packet after the output port or the destination port has been determined by the protocol unit for complex protocols. Modern simplified protocol concepts exhibit a rigid division between control/signaling and data transport (for example MPLS with LPD/RSVP-TE (Internet Draft), (method for the initialization of MPLS paths), (I-PoverWDM concepts, cf. for example RFC3031/3032/3034/3035)). As a result of the present invention, the data transport workload is kept extremely simple, the buffering workload (memory and memory speed) is very greatly limited and the coordination workload between distributed buffers is very significantly reduced (by means of traffic engineering and connection acceptance/establishment). The control/signaling traffic can thus differ in complexity and can also vary greatly in terms of processing requirement depending on the load situation (duration of connection maintenance) and can nevertheless be handled dynamically and flexibly.

As a result of the newer structures of networks, a major part of packet processing no longer takes place in the conventional protocol processing units, instead to begin with only a greatly simplified, fast classification and identification takes place in the internal coupling units, which can be both electrical and also optical in nature. The known transmission units are still employed only in exceptional cases. Thus, the protocol processing units only then need to handle those packets which are required for signaling (control packets, for example) and in those situations in which handling on a higher level is required. The coupling matrix now bears the main workload associated with packet forwarding and is connected to the network as a rule by way of extremely simple and standardized interfaces (point to point). To this end, primarily HDLC-like protocols come into consideration, such as for example the Simple Data Link Protocol (SDL, cf: Doshi, B. et al.: “A Simple Data Link Protocol for High Speed Packet Networks”, Bell Labs Technical Journal, pp. 85-104, Vol.4, No.1).

In a further embodiment, the ports are connected using optical conductors. With regard to a possible multi-stage method, purely optical lambda cross connectors with/without wavelength conversion are connected to MPLS/ATM couplers and IP router engines. In other embodiments, network processors which are capable of being tailored to future protocols of greater complexity through the use of appropriate software solutions will be used for routing.

The invention results in reduced demands on the packet processing performance of the overall architecture. When related to the overall throughput, the complete protocol processing, in other words that related to complex protocols, becomes a matter of handling exceptions. A flexible number of protocol modules can be connected according to requirements. The overall throughput is determined to a fairly major extent by the coupling units themselves, which can result in an increase in performance.

Transmission facilities are thus provided by the present invention. The coupling modules have ports which enable the connection to an external network and have at their inputs units for performing a fast classification of the data packets into those which are further processed in the coupling unit itself, and those which are to be forwarded to the protocol processing modules. This network is simply responsible for the communication with the protocol units. There is thus a rigid division between control and transport data traffic on the level of the units and modules.

The coupling units are provided with an additional logic element which handles a major part of the decisions which have been handled by protocol units in the past. The flow of information which is sent by more complex protocols is controlled by means of the known protocol units. As a result, it is possible to dispense with the handling of a major portion of the packets in the protocol modules. The major portion of the packet load is already being processed on the lowest protocol level.

### BRIEF DESCRIPTION OF THE DRAWINGS

The invention will be described in the following with reference to the drawings. In the drawings:

FIG. 1 shows a detailed design of a transmission unit.

FIG. 2 shows a detailed design of two transmission units, as shown in FIG. 1, whereby they are connected by an optical cross connector and E/O converter to an optical network.

### DETAILED DESCRIPTION OF THE INVENTION

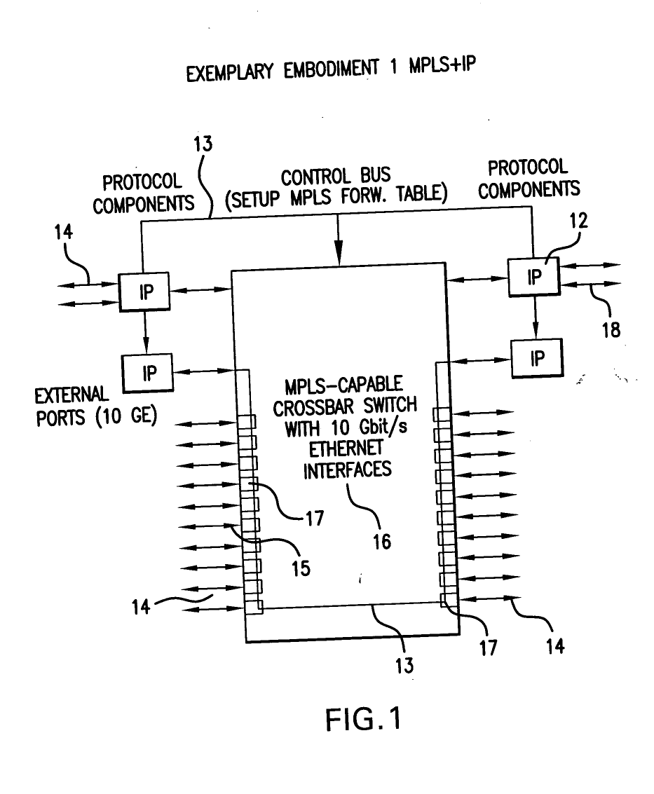

FIG. 1 shows an electrical embodiment of the present invention. Port units 14, also referred to as coupling units, are connected directly by means of 10-gigabit interfaces or ports 15 to the outside world, in other words an external network 18. Within these port units, a major portion of the packets is already forwarded in accordance with MPLS. The processing of the packets is handled by protocol units 17 for less complex protocols. Packets or their header information requiring an IP routing are first processed in connected protocol modules 12 and then forwarded by the coupling units or port units 14. The connection between the individual protocol units 12 and 17 is guaranteed by means of a network 13 which is used simply for the exchange of control information. Routing tables and MPLS tables are exchanged here. In addition, communication takes place with the aid of the aforementioned protocols described above. In a further embodiment, the network concerned is a hierarchical network which, depending on the protocol load to be expected, has different levels with different numbers of protocol units which are responsible for the corresponding protocols. The individual levels are arranged at different distances from the port units. The level having the most protocol units is immediately adjacent to the port units.

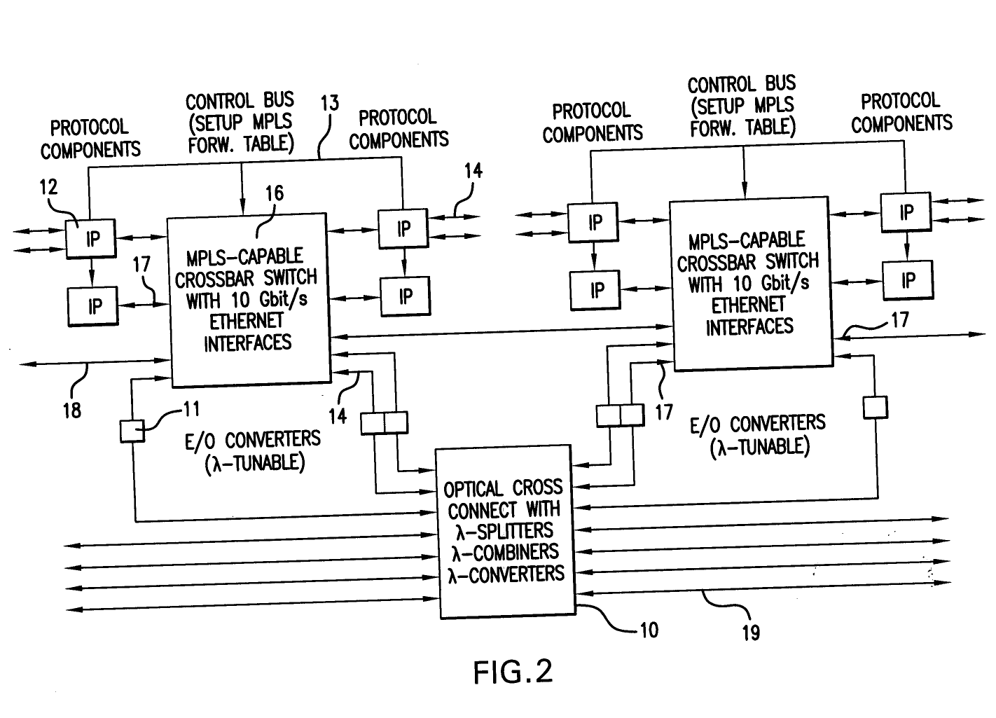

FIG. 2 shows an embodiment which is additionally based on the forwarding of data by means of an optical cross connect with wavelength conversion (and additional wavelength-dependent splitters combiners). According to the basic concepts for the so-called multi-protocol lambda switching (cf. D. Awduche et al.: “Multi-Protocol Lambda Switching: Combining MPLS Traffic Engineering with Optical Cross Connects”, Internet Draft, draft-awduche-mpls-te-optical-0 1.txt), bandwidth-intensive MPLS paths existing over some time are mapped onto separate wavelengths which are then forwarded solely in the cross connector 10. Certain wavelengths are reserved as previously for the conventional packet traffic. Their bit streams are converted opto-electrically and then as shown in FIG. 1 processed in the MPLS-capable crossbar (and, should the occasion arise, in the protocol modules). The connection with the port units 14 is effected by means of an E/O converter 11.

In a further embodiment, which is not shown, a special analysis unit is employed which carries out a pre-analysis of the signals or the information packets in order to ascertain which protocols are involved. Once this has been ascertained, the corresponding packet is forwarded to the corresponding protocol unit. In a special embodiment, a protocol unit which is preferably capable of processing simple protocols such as MPLS or ATM is immediately integrated in this analysis unit. This method ensures that the information is read and evaluated simultaneously with the analysis process without it having to be read a second time.

1. A device for transmitting a plurality of packet-oriented signals within networks comprising:
a plurality of port units comprising one or more ports, whereby the ports are configured to be connected to the networks;
a transmission unit which functions as a crossbar switch; and
at least one first protocol unit which analyzes at least part of the signals and determines their destination,
wherein
a plurality of other protocol units is present and directly associated with the port units, and classify the signals according to their transmission protocol to independently handle the protocol processing for part of the packets, depending on the transmission protocol, and to pass on the protocol processing for the other part to the first protocol unit.

2. The device according to claim 1, wherein the other protocol units only process protocols for which no memory-intensive and/or time-intensive operations are required to determine the destination of the signals.

3. The device according to the claim 1, wherein signals using the MPLS and/or ATM protocols are processed by the other protocol units.

4. The device according to claim 1, wherein at least one other protocol unit is associated with each port unit.

5. The device according to claim 1, wherein the protocol units each have at least one network interface by which the protocol units are connected to a network.

6. The device according to claim 1, wherein the protocol units exchange control signals with one another to provide switching and/or routing information.

7. The device according to claim 1, wherein the first protocol unit processes signals which are transported based on.

8. The device according to claim 1, wherein at least one part of the port units is connected optically by an E/O converter to an optical cross-connect to perform the switching and/or routing operations for the part.

9. A method for transmitting a plurality of packet-oriented signals within networks having a device which exhibits a hierarchy of protocol units, whereby depending on the protocols used, individual hierarchies of the protocol units are associated with a protocol and the number of protocol units in the hierarchy is dependent on a frequency of the protocol used, comprising:
analyzing the signal for determining the transfer protocol depending on the transmission protocol; and
assigning, based on the determined transfer protocol, the signal to a protocol unit in the hierarchy associated with the protocol, so that a corresponding protocol unit determines a destination to forward the signal to the transmission unit.
